(19) United States
(12) Patent Application Publication
(10) Pub. No.: US 2024/0124332 A1
(43) Pub. Date: Apr. 18, 2024

(54) Local algae control for submerged equipment

(71) Applicant: Antonio Davido Trigiani, Bristol, TN (US)

(72) Inventor: Antonio Davido Trigiani, Bristol, TN (US)

(21) Appl. No.: 18/487,746

(22) Filed: Oct. 16, 2023

Related U.S. Application Data
(60) Provisional application No. 63/416,204, filed on Oct. 14, 2022.

(51) Int. Cl. C02F 1/36; A01M 21/00; C02F 1/32

(52) U.S. Cl. CPC C02F 1/36; A01M 21/00; C02F 1/325; C02F 2103/007; C02F 2201/326

(57) ABSTRACT

Apparatus for protecting submerged equipment from biogrowth. In one embodiment, a submerged, underwater ultrasonic transducer assembly is enclosed in an isolation chamber that contains a zone that is free of bio organisms. The isolating chamber encloses the transducer assembly to provide an outer surface exposed to the body of water where that outer surface is distanced sufficiently from the transducer assembly to ensure algae is inhibited from growing on the outer surface. The isolating chamber is a water-tight enclosure filled with a liquid. In another embodiment, the transducer assembly is surrounded by a light array that directs illumination toward the assembly. The illumination is at a wavelength that inhibits biogrowth. The light array includes a plurality of light strips with spaced apart lights. The light strips are supported by a bracket such that the transducer assembly is fully exposed to the illumination from the light strips.

### CROSS-REFERENCE TO RELATED APPLICATIONS

This application claims the benefit of U.S. Provisional Application No. 63/416,204, filed Oct. 14, 2022.

### STATEMENT REGARDING FEDERALLY SPONSORED RESEARCH OR DEVELOPMENT

Not Applicable

### BACKGROUND

### 1. Field of Invention

This invention pertains to a device for local algae control. More particularly, this invention pertains to an underwater ultrasonic transducer or sensor assembly with an apparatus that controls algae growth on the submerged assembly. The apparatus includes either a passive isolation chamber around the submerged assembly or an active assembly that projects algae inhibiting light around the submerged assembly, thereby preventing biogrowth (biofilm, algae, and other organism growth) on the submerged assembly.

### BRIEF SUMMARY

According to one embodiment of the present invention, an apparatus for local algae control disposed around submerged equipment is provided. The local algae control apparatus is a protection device that creates a zone around submerged equipment that is inhospitable to biogrowth on the submerged equipment. Biogrowth includes biofilm, algae, and other organism growth on submerged objects. The protection device protects the submerged equipment from algae and other organism growth. In various embodiments, the submerged equipment includes underwater algae control ultrasonic transducers and/or water quality sensors or instrumentation.

According to one embodiment, the protection device includes an isolation chamber that surrounds the submerged equipment. For the embodiment where the submerged equipment is a transducer assembly, the equipment includes one or more ultrasonic elements that emit ultrasonic waves to control algae growth in a body of water. The isolation chamber encloses the transducer assembly to isolate the interior of the chamber from the water in the body of water. The isolation chamber is a water-resistant enclosure that prevents intrusion of outside water into the interior of the chamber. The chamber includes water-tight penetrations for the electrical cables and support structures connected to the transducer assembly. The chamber includes means for filling the inside with a liquid, where the liquid is treated to inhibit algae growth.

The isolation chamber is sized and shaped such that the outer surface is sufficiently distanced from the transducer assembly such that the outer surface is within the algae-inhibiting range of the ultrasonic elements. That is, the outer surface of the isolation chamber is at a distance from the ultrasonic elements that algae is prevented from growing on the outer surface. In one such embodiment, the distance is approximately six inches. In other embodiments, the distance is less than 12 inches. In yet another embodiment the distance is less than 18 inches. In still another embodiment the distance is less than 24 inches.

According to another embodiment, the protection device includes a plurality of lights arranged around an underwater algae control ultrasonic transducer assembly. The lights project illumination toward and around the submerged equipment. The projected light is electromagnetic radiation of various wavelengths, either visible or not visible to humans. In particular, the projected light is radiation having a frequency or wavelength or color temperature that is inhospitable to the algae or other organism being targeted.

In one such embodiment, the plurality of lights are sequenced to be on or illuminated with a selected pattern. For example, for a protection device with four lights or light strips, one light is illuminated while the other lights are not illuminated. After a selected time, the illuminated light is turned off and another light is illuminated for a selected time. This continues for a full cycle in which all of the lights are illuminated sequentially for a selected time.

### BRIEF DESCRIPTION OF THE SEVERAL VIEWS OF THE DRAWINGS

The above-mentioned features will become more clearly understood from the following detailed description read together with the drawings in which:

FIG. 1 is a symbolic view of one embodiment of an ultrasonic algae control system that includes one embodiment of a transducer assembly with a first embodiment of a protection device.

FIG. 2 is an isometric view of another embodiment of a protection device that is an isolation chamber.

FIG. 3 is an isometric view of yet another embodiment of the isolation chamber.

FIG. 4 is an isometric view of a first embodiment of a protection device that is a light array where the protection device has a cylindrical configuration.

FIG. 5 is an isometric view of a second embodiment of a protection device that is a light array where the protection device has a suspended configuration.

FIG. 6 is an isometric view of a third embodiment of a protection device that is a light array where the protection device has a first embodiment of a mounted configuration.

FIG. 7 is block diagram of a one embodiment of a control circuit.

FIG. 8 is a partial side view of a fourth embodiment of a protection device that is a light array where the protection device has a second embodiment of an attachment member.

FIG. 9 is a partial cross-sectional view of the second embodiment of the attachment member of FIG. 8.

FIG. 10 is a symbolic view of the radiation patterns for the ultrasonic waves and the light illumination.

### DETAILED DESCRIPTION

Apparatus for a protection device 100 that that creates a zone around submerged equipment that is inhospitable to algae and other organism growth on submerged equipment 114 is provided. Various components and elements, such as the protection device 100-A1, 100-A2, 100-B1, 100-B2, 100-B3, 100-B4 have their particular embodiments and variations shown in the figures and described below with an alphanumeric suffix. When referencing those components and elements generally, though, the suffix is omitted, such as when referencing the protection device 100 generically. Positional references, such as top and bottom and horizontal and vertical, refer to the configuration of the protection device 100 as it is deployed for use. For example, the top is considered to be closer to the surface of the body of water 102 than the bottom, and horizontal is considered parallel to the surface of the body of water 102 when the protection device 100 is deployed in the water 102.

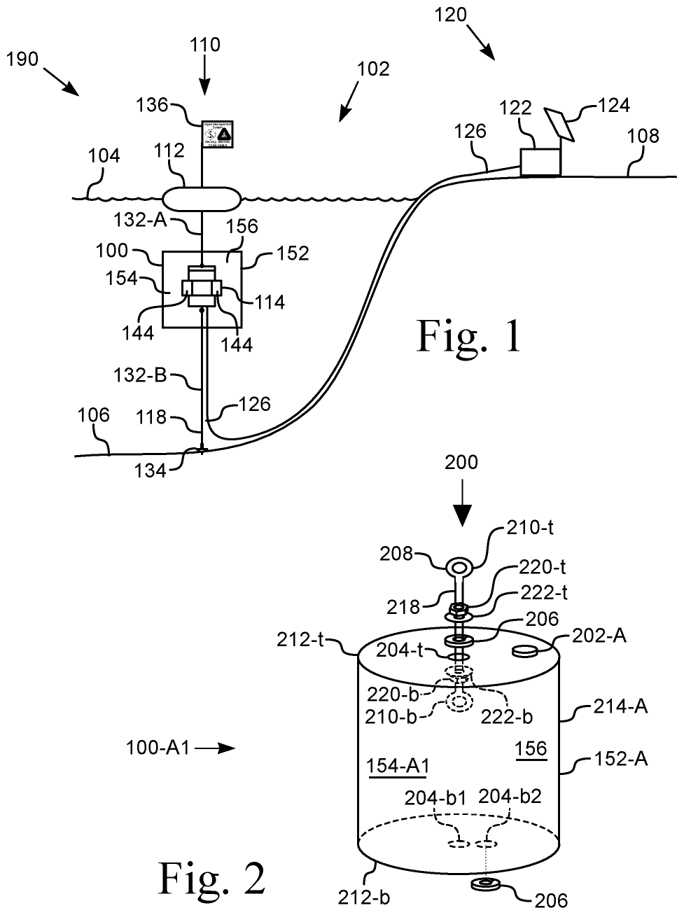

FIG. 1 illustrates a symbolic view of one embodiment of an ultrasonic algae control system 190 that includes a protection device 100 positioned around a transducer assembly 114, which is one embodiment of a piece of submerged equipment.

The algae control system 190 includes a power supply unit 120 electrically connected to a transducer unit 110. The algae control system 190 is configured to be used with a body of water 102, such as a lake, a stream or river, a pond, a swimming pool, a spa or hot tub, or other body of water 102 in which algae overgrowth is to be controlled or eliminated. The illustrated embodiment of the transducer unit 110 is a floating device. The transducer unit 110 includes a float 112 with a flag 136, a sonic head, or transducer assembly, 114, and an anchor system 118. The float 112 and anchor system 118 define the support structure for the sonic head 114. The support structure supports the sonic head 114 at a desired position and depth in the body of water 102.

The transducer unit 110 is configured to float in a body of water 102, such as a pond, reservoir, or small lake. The float 112 is buoyant and rests on or near the surface 104 of the body of water 102. The float 112 has sufficient buoyancy to support the floating transducer unit 110 and a portion of the cable 126 with the float 112 at the surface 104 of the water 102. Extending above the float 112 is a flag 136. The flag 136 has a flag pole and a banner with markings. The flag 136 warns boaters and other waterborne users that there is an electrical device present in the vicinity.

Suspended below the float 112 is the sonic head, or transducer assembly, 114. In one embodiment, the sonic head 114 is generally 0.3 to 0.4 meters below the surface 104 of the water 102. In other embodiments, the depth of the sonic head 114 varies based on the requirements of the specific application configuration. For example, in a swimming pool or hot tub, the depth of the water 102 is such that the sonic head 114 provides adequate coverage when mounted on or near the bottom 106. In one such embodiment, the sonic head 114 is supported by an attachment to the bottom or sidewall of the pool or tub.

The sonic head, or transducer assembly, 114 include multiple ultrasonic elements 144 that radiate around the circumference of the transducer assembly 114. In the illustrated embodiment, the transducer assembly 114 shows a single set of ultrasonic elements 144 arranged horizontally at 90 degree intervals around the circumference of the transducer assembly 114. In the illustrated embodiment, the transducer assembly 114 has an octagonal-shaped center section with a set of ultrasonic elements 144 associated with every other surface. In another embodiment, two sets of ultrasonic elements 144 are deployed with each element 144 associated with one of the eight octagonal sides of the transducer assembly 114.

The float 112 is anchored to the bottom 106 of the body of water 102 by the anchor system 118. The anchor system 118 includes an anchor line 132 and an anchor 134 that engages the bottom 106. In one embodiment the sonic head 114 has an upper attachment point 202 for connecting to the float 112 by way of the upper anchor line 132-A and a lower attachment point 202 for connecting to the anchor system 118 by way of the lower anchor line 132-B. In another embodiment the anchor system 118 is attached to the float 112 and the sonic head 114 attaches to the anchor line 132-A.

In another embodiment of the transducer unit 110, the sonic head 114 is buoyant or is attached to a float, and the sonic head 114 is secured to the bottom 106 with an anchor 134. The length of the lower anchor line 132-B between the sonic head 114 and the anchor 134 establishes the depth of the sonic head 114 below the surface 104 of the body of water 102. In yet another embodiment of the transducer unit 110, the transducer unit 110 is secured to a support surface, such as a wall or bottom 106 of the body of water 102, with the sonic head 114 protruding from the support surface into the body of water 102. Such an embodiment is suitable for a body of water 102 that is a small pond or a swimming pool where the volume of water to be treated by the transducer unit 110 is small enough that the position of the sonic head 114 is not critical to ensuring that the algae is controlled. For such a body of water 102, the transducer unit 110 protruding from the support surface is unobtrusive while still being effective.

The illustrated power supply unit 120 is positioned on land 108 next to the body of water 102. The power supply unit 120 includes at least one solar panel 124 and a power unit 122, which provides power when a mains power supply is not available. In another embodiment, the power supply unit 120 is connected to a mains supply. A cable 126 connects the power supply unit 120 to the transducer unit 110. The cable 126 provides power and bidirectional control signals to and from the transducer unit, or sonic head, 110.

In another embodiment the power supply unit 120 includes a floating platform that is anchored in the body of water 102. For example, the power supply unit 120 is supported by dock floats, which are also the float 112 that forms part of the floating transducer unit 110. The power unit 122, battery pack, and solar panel 124 secured above the surface 104 of the body of water 102 by the float 112. In this way the power supply unit 120 and the floating transducer unit 110 are an integral unit. The integral combination of the power supply unit 120 and floating transducer unit 110 is able to be powered solely from the solar panel 124 (and associated battery) without reliance upon a mains power source. A further advantage of the integral combination is that the cable 126 has a short length, thereby minimizing power loss due to cable resistance. In yet another embodiment, the power supply unit 120 and the floating transducer unit 110 are an integral unit configured to be secured or attached to a structure in or defining the body of water 102, for example, the wall or floor of a swimming pool.

The protection device 100 is positioned around the transducer assembly 114. The protection device 100 defines a zone 154 bounded by the protection device 100. The zone 154 is a volume where algae and organism growth is inhibited. In one embodiment, the protection device 100 is an isolation chamber 100-A. In another embodiment, the protection device 100 is a light array 100-B. And in yet another embodiment, the protection device 100 is a combination of an isolation chamber 100-A with a light array 100-B.

In various embodiments, the protection device 100 is an isolation chamber 100-A. In such embodiments, which are illustrated in FIGS. 2 & 3, the isolation chamber 100-A has an outer surface 152 that is in contact with the body of water 102. The outer surface 152 defines a boundary between the body of water 102 and a cavity, or zone, 154 that is bounded by the protection device 100. The boundary defined by the outer surface 152 seals the cavity 154 inside the chamber 100 from the water 102 outside the outer surface 152. In one embodiment, the boundary defined by the outer surface 152 is water-tight, that is, the water 102 on the outside of the outer surface 152 is not able to pass into the cavity 154.

In another embodiment, the boundary defined by the outer surface 152 is water-resistant, that is, the water 102 on the outside of the outer surface 152 is inhibited from passing into the cavity 154, although there may be some slight leakage. The chamber 100 is sized and configured such that the outer surface 152 is within the algae-inhibiting range of the ultrasonic elements 144. The ultrasonic elements 144 emit ultrasonic waves that adversely affect algae in the water, inhibiting the growth of algae and, in ideal cases, killing the algae in the water 102. Generally, the ultrasonic waves are most effective at some distance away from the ultrasonic emitting surface of the element 144. To minimize algae growth on the outer surface 152, the outer surface 152 is located in range of the ultrasonic waves that inhibit and/or kill micro-organisms. In one case, algae that is at least six inches away from the emitting surface of the ultrasonic element 144 is affected while algae closer than six inches are substantially unaffected. In some cases, algae growth on the emitting surface of the ultrasonic element 144 occurs. To prevent such occurrence, the outer surface 152, in one such embodiment, is a minimum of six inches away from the emitting surface of the ultrasonic element 144. In this way, there will be no algae growth on the outer surface 152.

Inside the chamber 100 is a cavity 154 that contains a liquid 156. In one embodiment, the liquid 156 in the cavity 154 is treated to inhibit algae growth. For example, the liquid is water that includes chlorine in sufficient quantity to prevent and/or inhibit formation of a biofilm on the transducer assembly 114 and/or growth of algae in the cavity 154. The liquid 156 and the chamber 100 are both transparent to ultrasonic waves emitted by the ultrasonic elements 144.

In one embodiment, the chamber 100 is a material that is sufficiently rigid that the chamber 100 does not deform under its own weight. That is, the chamber 100 is a rigid material that maintains its shape and configuration before and after filling with liquid 156 and before and after the chamber 100 is deployed in the body of water 102. In various embodiments, the chamber 100 is a material that is a metal or a polymer. In another embodiment of the chamber 100, the chamber 100 is a material that is flexible such that the chamber 100 assumes its deployed shape and configuration after the cavity 154 is filled with liquid 156 and the cavity 154 is sealed around the transducer assembly 114.

In another embodiment, the protection device 100 is a light array 100-B. The light array 100-B includes an array of lights 402 suspended from a support 414. The array of lights 402 include vertically aligned light strips 402 with LEDs 404 illuminating the suspended equipment 114 in the zone 154.

In another embodiment, the protection device 100 is a combination of an isolation chamber 100-A and a light array 100-B. The array of lights 402 is supported by the isolation chamber 100-A. For example, in one such embodiment the cylindrical isolation chamber 100-A1 also supports the plurality of light strips 402-A, 402-B, 402-C, 402-D, such as illustrated in FIG. 4.

FIG. 2 illustrates an isometric view of a first embodiment of the protection device 100-A1. The illustrated embodiment of the protection device 100-A1 is an isolation chamber positioned around the transducer assembly 114 such that the transducer assembly 114 is completely surrounded by the isolation chamber 100-A1.

The illustrated protection device 100-A1 has a cylindrical shape with a vertical wall 214-A, a top plate 212-t, and a bottom plate 212-b. The outer surface 152-A is defined by the vertical wall 214-A, the top plate 212-t, and the bottom plate 212-b.

An attachment mechanism 200 secures the protection device 100-A around submerged equipment 114. The attachment mechanism 200 forms a water-tight connection to the isolation chamber 100-A1. The attachment mechanism 200 includes an eyebolt 208 and associated pieces. The top plate 212-t includes an upper opening 204-t through which the eyebolt 208 passes. In one embodiment, the upper anchor line 132-A is a rope or cable that engages an upper eyelet 210-t in an eyebolt 208. The eyebolt 208 has a threaded end that passes through the upper opening 204-t. The eyebolt 208 engages a sealing washer 206, a fender washer 222-t, and a nut 220-t positioned on the top side of the top plate 212-t. The eyebolt 208 engages a washer 206 for sealing the chamber 100-A1, a fender washer 222-b, and a nut 220-b positioned on the bottom side of the top plate 212-t. The two nuts 220-t, 220-b engage the eyebolt 208 so as to compress the sealing washer 206 against the top plate 212-t, thereby sealing the upper opening 204-t. The lower eyelet 210-b is the type with a threaded opening that engages the threaded shaft of the eyebolt 208. In this way the lower eyelet 210-b is positioned to engage the top portion of the transducer assembly 114, there by holding the transducer assembly 114 in a fixed relationship with the chamber 100-A.

The bottom plate 212-b includes a first lower opening 204-b1 through which a second eyebolt 208 passes in a similar manner as the eyebolt 208 does with the upper opening 204-t. The illustrated embodiment includes a second lower opening 204-b2 through which the electrical cable 126 passes. A sealing washer 206 engages the cable 126 where it passes through the second lower opening 204-b2, thereby sealing the second lower opening 204-b2. The sealing washer 206, in one embodiment, is a resilient, split washer with a groove for engaging a plate. Such a washer 206 is adapted to fit around a continuous cable 126 and also engage both the inside and outside surfaces of the bottom plate 212-b.

In another embodiment, the upper and lower anchor lines 132-A, 132-B are wire cables or similar that pass through respective sealing washers 206 before attaching to the transducer assembly 114. In yet another embodiment, the lower anchor line 132-B and the electrical cable 126 pass through a single sealed opening 204.

The isolation chamber 100-A includes a cap 202-A on or near the top plate 212-t. In one embodiment, the cap 202-A is removable so that the cavity 154-A receives a liquid 156 that fills the isolation chamber 100-A when the cap 202-A is removed. The cap 202-A allows for adding and removing the liquid 156 while also ensuring that the chamber 100-A is sealed when the cap 202-A is deployed in place.

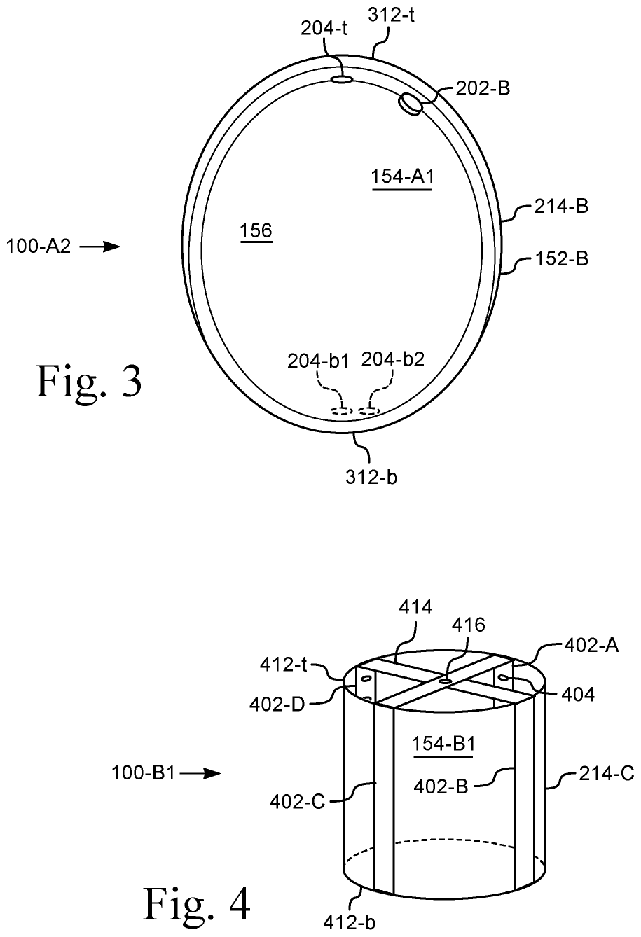

FIG. 3 illustrates an isometric view of a second embodiment of the isolation chamber 100-A2. The illustrated embodiment of the isolation chamber 100-A2 is similar to the isolation chamber 100-A1 shown in FIG. 2 except that the isolation chamber 100-A2 has an ellipsoidal shape as illustrated in FIG. 3.

The illustrated chamber 100-A2 has an ellipsoidal shape with an outer curved wall 214-B that defines the cavity 154-B. In various embodiments, the ellipsoidal shape of the chamber 100-A2 is spherical, ovoid, or a combination of ellipsoidal and polyhedral. The chamber 100-A2 has a top section 312-t and a bottom section 312-b. The outer surface 152-B is defined by the outer curved wall 214-B. The outer surface 152-B is bounded by the top section 312-t and the bottom section 312-b.

The top section 312-t includes an upper sealed opening 204-t through which the upper anchor line 132-A passes. In one embodiment, the upper anchor line 132-A is a rope or cable that engages the upper sealed opening 204-t with a water-tight seal.

The bottom section 312-b includes a first lower sealed opening 204-b1 through which the lower anchor line 132-B passes. In one embodiment, the lower anchor line 132-B is a rope or cable that engages the first lower sealed opening 204-b1 with a water-tight seal. The illustrated embodiment includes a second lower sealed opening 204-b2 through which the electrical cable 126 passes. In another such embodiment, the electrical cable 126 exits from the top of the transducer assembly 114 and the second sealed opening 204-b2 is located on the top plate 212-t. In yet another embodiment, the lower anchor line 132-B and the electrical cable 126 pass through a single sealed opening 204.

The isolation chamber 100-A2 includes a cap 202-B positioned near the top section 312-t. In one embodiment, the cap 202-B is removable so that the cavity 154-B receives the liquid 156 that fills the isolation chamber 100-A2 when the cap 202-B is removed. The cap 202-B allows for adding and removing the liquid 156 while also ensuring that the chamber 100-A2 is sealed when the cap 202-B is deployed in place.

The cap 202 allows for filling and/or emptying the cavity 154 with a fluid 156. In one embodiment, the cap 202 includes a threaded cover that engages a corresponding threaded opening. In another embodiment, the cap 202 includes a plug that frictionally engages an opening in the chamber 100-A.

In various embodiments, the fluid 156 is a liquid that passes the ultrasonic waves emitted by the transducer assembly 114. In one such embodiment, the fluid 156 includes water with an addition that inhibits organism growth in the fluid 156. For example, the addition is chlorine or a chlorine solution. In another such embodiment, the fluid 156 is gelatinous, which aids in inhibiting leakage through any openings 204 that are imperfectly sealed. In yet another such embodiment, the fluid 156 is a liquid with a lower density than the surrounding water 102 and the chamber 100 is not sealed on the bottom side 212-B, 312b. In this way, the fluid 156 remains in the cavity 154, thereby protecting the transducer assembly 114 from contact with the surrounding water 102.

In one embodiment, the isolation chamber 100 includes a cleaning mechanism. The cleaning mechanism includes a motor driving a wiper and, in one embodiment, a timer. Motor is operatively controlled by the timer. The timer periodically operates the motor, for example, once a week or month for a selected time period. The wiper is operatively connected to the motor, which causes the wiper to engage at least a portion of the outer surface 152 of the wall 214 of the chamber 100. In various embodiments, the wiper is a brush or a squeegee that moves circumferentially around the outer surface 152 to displace any foreign material that has accumulated on the outer surface 152.

In one such embodiment, the motor of the cleaning mechanism is electrically connected to the transducer assembly 114. In one embodiment, the motor has a central or axial member that is stationary and an outer member that rotates about the axial member. The axial member is connectable to the anchor line 132-A, 132-B and the transducer assembly 114. The outer member is connected to the wiper, which rotates around the axial member. In this way, the wiper and the portion connecting the wiper blade to the outer member rotates freely without being obstructed by the anchor line 132-A, 132-B.

FIG. 4 illustrates an isometric view of a first embodiment of a protection device 100-B1 that is a light array 100-B1 with a cylindrical configuration. The illustrated first embodiment of the protection device 100-B1 includes a support member 414, a vertical wall 214-C with a cylindrical shape, and a plurality of light strips 402-A, 402-B, 402-C, 402-D.

The support member 414 is positioned at the top 412-t of the cylindrical member 214-C. The support member 414 includes an opening 416 suitable for attaching the protection device 100-B1 to the ultrasonic algae control system 190. For example, an eyebolt 208, such as described with respect to FIG. 2, engages the opening 416 to support the protection device 100-B1 around the submerged equipment 114.

The vertical wall 214-C has a cylindrical shape that is open at the top 412-t and the bottom 412-b. In another embodiment, the vertical wall 214-C and the top 412-t and the bottom 412-b are configured as the wall 214-A and the top 212-t and the bottom 212-b illustrated in FIG. 2. In such an embodiment, the light array 100-B1 is combined with the isolation chamber 100-A.

The light strips 402-A, 402-B, 402-C, 402-D each have a plurality of lights 404 that are directed toward the zone 154-B1. The zone 154-B1 is defined as the space between the plurality of light strips 402-A, 402-B, 402-C, 402-D. In one embodiment, the lights 404 are light emitting diodes (LEDs) attached to a strip. The lights 404 emit light at a specific wavelength that is inhospitable to algae or organisms targeted. In one such embodiment, the lights 404 emit light in the ultraviolet range.

In one embodiment, the lights 404 are spaced apart vertically at one-inch intervals and each light strip 402-A, 402-B, 402-C, 402-D is twelve inches long. In the illustrated embodiment, the lights 404 are on light strips 402-A, 402-B, 402-C, 402-D positioned at 90 degree intervals around the circumference of the vertical wall 214-C. Those skilled in the art will recognize that a different number of light strips 402 can be used without departing from the spirit and scope of the present invention. The number of light strips 402 depends upon the dispersion of illumination 1002 from the lights 404.

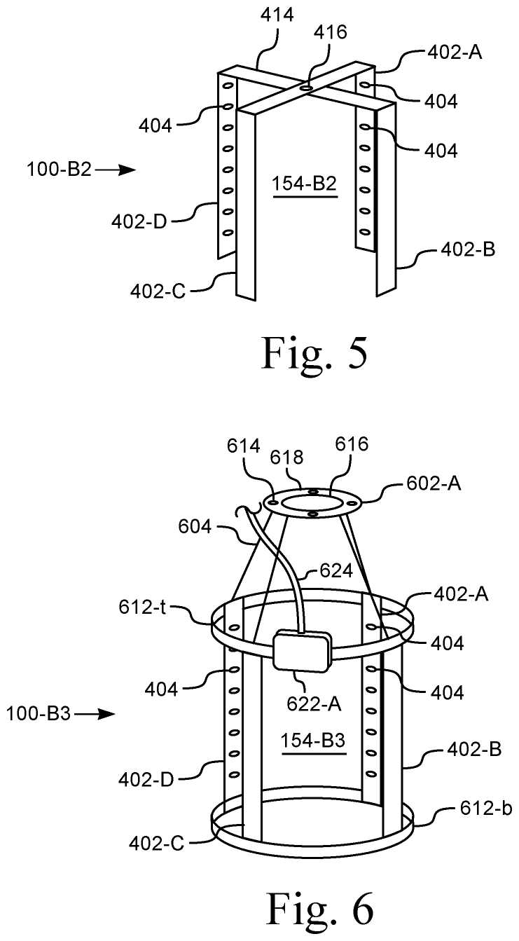

FIG. 5 illustrates an isometric view of a second embodiment of a protection device 100-B2 that is a light array 100-B1 with a suspended configuration. The illustrated second embodiment of the protection device 100-B2 includes a support member 414 and a plurality of light strips 402-A, 402-B, 402-C, 402-D suspended from the support member 414.

The support member 414 is positioned at the top 412-t of the plurality of light strips 402-A, 402-B, 402-C, 402-D. The support member 414 includes an opening 416 suitable for attaching the protection device 100-B1 to the ultrasonic algae control system 190. For example, an eyebolt 208, such as described with respect to FIG. 2, engages the opening 416 to support the protection device 100-B1 around the submerged equipment 114.

The light strips 402-A, 402-B, 402-C, 402-D each have a plurality of lights 404 that are directed toward the zone 154-B2. The zone 154-B2 is defined as the space between the plurality of light strips 402-A, 402-B, 402-C, 402-D. In one embodiment, the lights 404 are light emitting diodes (LEDs) attached to a strip. The lights 404 emit light at a specific wavelength that is inhospitable to algae or organisms targeted. In one such embodiment, the lights 404 emit light in the ultraviolet range.

In the illustrated embodiment, the lights 404 are on light strips 402-A, 402-B, 402-C, 402-D positioned at 90 degree intervals around the circumference of the vertical axis passing through the opening 416. Those skilled in the art will recognize that a different number of light strips 402 can be used without departing from the spirit and scope of the present invention.

FIG. 6 illustrates an isometric view of a third embodiment of a protection device 100-B3 that is a light array 100-B1 with a first embodiment of a mounted configuration. The illustrated third embodiment of the protection device 100-B3 includes a first embodiment of an attachment member 602-A supporting a top ring 612-t with a plurality of light strips 402-A, 402-B, 402-C, 402-D suspended from the top ring 612-t and secured by a bottom ring 612-b.

The first embodiment of the attachment member 602-A is planar, washer-type ring that has a top surface 618 configured to mate with the bottom of the raft or float 112. The member 602-A includes an opening 616 through which the wiring and/or support cable or line 132-A pass. The member 602-A also includes a plurality of fastener openings 614 through which fasteners pass for securing the attachment member 602-A to the float 112.

At least three support members 604 extend downward from the attachment member 602-A. The support members 604 connect the attachment member 602-A to the lower portion of the light array 100-B3. The support members 604 have a lower end that attaches to a top ring 612-t. The light strips 402 extend downward from top ring 612-t. The bottom ends of the light strips 402 are secured with a bottom ring 612-b.

The light strips 402-A, 402-B, 402-C, 402-D each have a plurality of lights 404 that are directed toward the zone 154-B3. The zone 154-B3 is defined as the space between the plurality of light strips 402-A, 402-B, 402-C, 402-D. In one embodiment, the lights 404 are light emitting diodes (LEDs) attached to a strip. The lights 404 emit light at a specific wavelength that is inhospitable to algae or organisms targeted. In one such embodiment, the lights 404 emit light in the ultraviolet range.

In the illustrated embodiment, the lights 404 are on light strips 402-A, 402-B, 402-C, 402-D positioned at 90 degree intervals around the circumference of the vertical axis passing through the opening 416. Those skilled in the art will recognize that a different number of light strips 402 can be used without departing from the spirit and scope of the present invention.

Attached to the top ring 612-t is a local controller or control unit 622-A. The local controller 622-A includes a cable 624 extending therefrom. The cable 624 connects the local controller 622-A to the electrical system in the raft or float 112 or in the sonic head 114. The local controller 622-A is electrically connected to each of the light strips 402-A, 402-B, 402-C, 402-D. In one embodiment, the top ring 612-t includes electrical conductors that provide an electrical connection between the local controller 622-A and each of the light strips 402-A, 402-B, 402-C, 402-D.

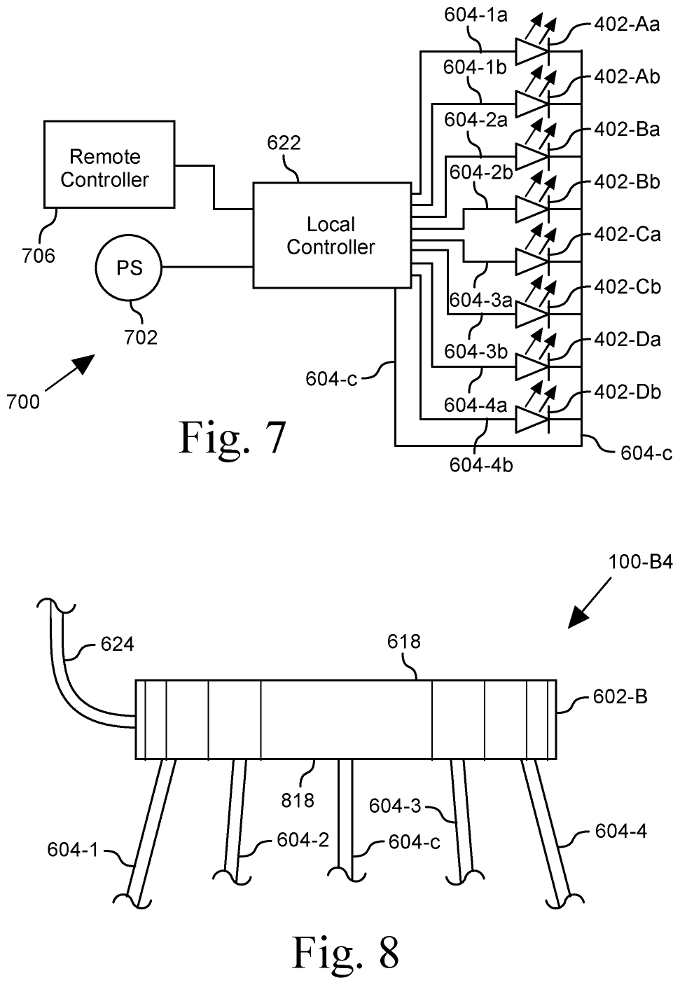

FIG. 7 illustrates a block diagram of a one embodiment of a control circuit 700 for the protection device 100-B that includes a light array. The control circuit 700 includes a power supply 702 and a remote controller 706, both connected to a local controller 622. The local controller 622 is connected to the light strips 402-A, 402-B, 402-C, 402-D.

In one embodiment, the power supply 702 is a part of the power unit 122. In another embodiment, the power supply 702 is an independent power source, such as a battery system.

The remote controller 706 is a device that sends operating signals to the local controller 622. In various embodiments, the remote controller 706 includes a user interface that interacts with a processing unit associated with the algae control system 190. The user interface receives user inputs and commands. The processing unit interprets those inputs and commands, along with other parameters and measured local conditions, to send the operating signals to the local controller 622.

The local controller 622 receives those operating signals and executes a program that switches the power applied to the various light strips 402 in a specific pattern with a specific on-time and off-time. For example, a human operator decides on an operating time and duty cycle for the light strips 402-A, 402-B, 402-C, 402-D. The operator uses an interface associated with the remote controller 706 to send signals to the local controller 622 that controls the sequence of illumination of the light strips 402-A, 402-B, 402-C, 402-D and the duration of illumination and the duty cycle for each light strip 402-A, 402-B, 402-C, 402-D.

The local controller 622 provides power to the light strips 402-A, 402-B, 402-C, 402-D. The local controller 622 also controls the times each of the light strips 402-A, 402-B, 402-C, 402-D is turned on to provide illumination to inhibit biogrowth. In one embodiment, power is applied to the light strips 402 with a duty cycle controlled by the local controller 622. FIG. 7 shows that each light strip 402-A, 402-B, 402-C, 402-D has an individual power conductor 604-1, 604-2, 604-3, 604-4 and the light strips 402-A, 402-B, 402-C, 402-D have a common conductor 604-c. In this way, each light strip 402-A, 402-B, 402-C, 402-D is individually controlled by the local controller 622.

In the illustrated embodiment, each of the light strips 402-A, 402-B, 402-C, 402-D includes at least two sets of lights 404 on each light strip 402-A, 402-B, 402-C, 402-D. Each set of lights 404 illuminates at a specified wavelength in order to target a specific micro-organism. That is, each light strip 402-A, 402-B, 402-C, 402-D includes a first sub-strip 402-Aa, 402-Ba, 402-Ca, 402-Da that operates at a first wavelength and a second sub-strip 402-Ab, 402-Bb, 402-Cb, 402-Db that operates at a second wavelength. Each sub-strip is controlled by an individual power conductor 604-1a, 604-2a, 604-3a, 604-4a, 604-2b, 604-3b, 604-1b, 604-4b, respectively. In this way each set of sub-strips 402-Aa, 402-Ba, 402-Ca, 402-Da, 402-Ab, 402-Bb, 402-Cb, 402-Db is controlled individually by the local controller 622. In other embodiments, each of the light strips 402-A, 402-B, 402-C, 402-D includes only a single set of lights 404 that illuminates at a specific wavelength.

As used herein, the local controller 622 should be broadly construed to mean any computer or component thereof that executes software. In various embodiments, the local controller 622 is one of a general purpose computer processor or a specialized device for implementing the functions of the invention. The local controller 622 includes a memory medium that stores software and data, a processing unit that executes the software, and input/output (I/O) units for communicating with external devices. Those skilled in the art will recognize that the memory medium associated with the local controller 622 can be either internal or external to the processing unit of the processor without departing from the scope and spirit of the present invention.

The input component receives input from external devices, such as the remote controller 706. The output component sends output to external devices, such as the light strips 402-A, 402-B, 402-C, 402-D. The storage component stores data and program code. In one embodiment, the storage component includes random access memory and/or non-volatile memory

In one embodiment, the local controller 622 operates the light strips 402 with a selected duty cycle. That is, the light strips 402 are turned on for a specific on-time and turned off for a specific off-time. For example, the light strips 402-A, 402-B, 402-C, 402-D are turned on for one second and turned off for three seconds for one cycle.

In one embodiment, the local controller 622 operates the light strips 402-A, 402-B, 402-C, 402-D in sequence. That is, each light strip 402-A, 402-B, 402-C, 402-D is turned on one-at-time with the other light strips 402-A, 402-B, 402-C, 402-D turned off. For example, one light strip 402-A, 402-B, 402-C, 402-D is turned on for one second and turned off for three seconds for one cycle. In this way, the inhibition of biogrowth is balanced with power usage.

In one embodiment, the lights 404 on the light strips 402-A, 402-B, 402-C, 402-D are UV-C type LEDs. In such an embodiment, the lights 404 emit illumination 802 at around 265 nm.

FIG. 8 illustrates a partial side view of a fourth embodiment of a protection device 100-B4 that is a light array where the protection device has a second embodiment of an attachment member 602-B. The attachment member 602-B includes the local controller 622 with an overmolded enclosure that seals the local controller 622 from the water environment.

The attachment member 602-B has a top member 618 that mates with the bottom of the raft or float 112 or connected to the sonic head 114. Extending from the side of the attachment member 602-B is a cable 624. The cable 624 connects the local controller 622-B inside the attachment member 602-B to the electrical system in the raft or float 112.

Extending from the bottom surface 818 are electrical conductors 604-1, 604-2, 604-3, 604-4, 604-c. The conductors 604 provide both structural support and electrical connectivity. The conductors 604 provide mechanical support of the lower section of the protection device 100-B4 as illustrated in FIG. 6. That is, the attachment member 602-B supports the top and bottom rings 612-t, 612-b and the light strips 402. The conductors 604 provide electrical connections to the light strips 402 as shown in FIG. 7.

The local controller 622-A is electrically connected to each of the light strips 402-A, 402-B, 402-C, 402-D. In one embodiment, the top ring 612-t includes electrical conductors that provide an electrical connection between the local controller 622-A and each of the light strips 402-A, 402-B, 402-C, 402-D.

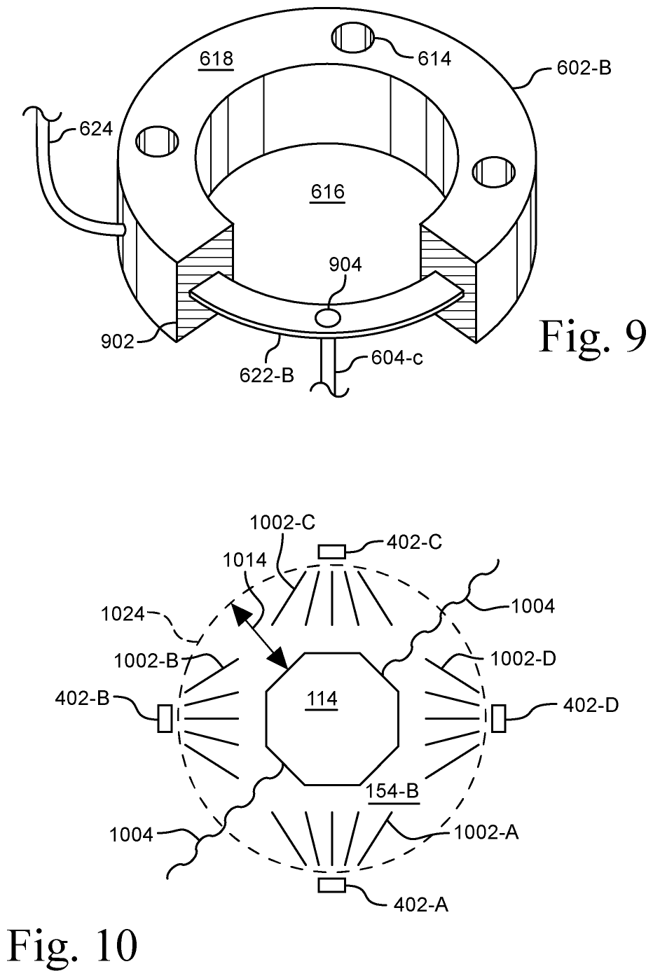

FIG. 9 illustrates a partial cross-sectional view of the second embodiment of the attachment member 602-B of FIG. 8. The cross-sectional view of the attachment member 602-B shows the cable 624 extending from the side of the overmold 902. A portion of the overmold 902 is cut-away to expose the local controller 622-B and connection of one conductor 604-c to the controller 622-B.

The local controller 622-B in the illustrated embodiment is a ring-shaped printed circuit board that contains the components that operate the light strips 402. The exposed portion of the controller 622-B shows a fastener 904 on the top side of the controller 622-B and one of the conductors 604-c extending from the bottom side of the controller 622-B. The end of the conductor 604-c is attached, both mechanically and electrically, to the controller 622-B by the fastener 904. In this way, the conductors 604 provide both mechanical support of the lower portions of the protection device 100-B4 and electrical connections to the light strips 402-A, 402-B, 402-C, 402-D.

The overmolding 902 encapsulates the local controller 622-B and the conductors 604 where the conductors 604 connect to the local controller 622-B. The overmolding 902 around the controller 622-B and the conductors 604 protects the controller 622-B and the conductors 604 from water intrusion when submerged in the body of water 102.

FIG. 10 illustrates a symbolic view of the radiation patterns for the ultrasonic waves 1004 and the light illumination 1002 when viewing the submerged equipment 114 from a vertical direction when the equipment 114 is submerged. The submerged equipment 114 is an ultrasonic transducer assembly 114 that emits ultrasonic waves 1004 in the water 102 360 degrees around the transducer assembly 114. FIG. 10 illustrates ultrasonic waves 1004 radiating away from transducer assembly 114 in two directions. Those skilled in the art will recognize that the ultrasonic waves 1004 radiate away from each transducer in the assembly 114 with a radiation pattern specific to the transducer. In one embodiment, the transducer assembly 114 includes transducers that radiate ultrasonic waves 1004 so as to provide 360 degree coverage in a plane parallel to the surface 104 of the body of water 102.

Generally, ultrasonic waves 1004 from a transducer are not effective for inhibiting biogrowth within a close distance 1014 from the transducer. As illustrated, the boundary 1024 of the ultrasonic waves 1004 is a distance 1014 from the transducer assembly 114. For a transducer assembly 114 with a 360 degree radiation pattern, the boundary 1024 has a truncated ovoid shape that has a circular cross-section, such as illustrated in FIG. 10, when viewed along a vertical axis.

The light strips 402-A, 402-B, 402-C, 402-D direct illumination 1002-A, 1002-B, 1002-C, 1002-D toward the submerged equipment 114. The illumination 1002-A, 1002-B, 1002-C, 1002-D diverges and spreads from the respective light strips 402-A, 402-B, 402-C, 402-D. In this way, the submerged equipment 114 is fully bathed in the illumination 1002, which inhibits growth of bio-organisms on the equipment 114.

In the illustrated embodiment, the light strips 402-A, 402-B, 402-C, 402-D are located outside the closest effective ultrasonic wave 1004. The closest effective ultrasonic wave 1004 is defined as a distance 1014 beyond which the ultrasonic wave 1004 affects the viability of bio-organisms. The distance 1014 defines a boundary 1024 beyond which bio-organism growth and viability is adversely impacted. The boundary 1024 is defined as the limit of the zone 154-B where the ultrasonic waves 1004 have limited impact on bio-organisms.

As illustrated in FIG. 10, the light strips 402-A, 402-B, 402-C, 402-D are positioned further away from the ultrasonic transducer assembly 114 than the distance 1014. In this way, the portion of the zone 154-B not affected by ultrasonic waves 1004 are exposed to the illumination 1002-A, 1002-B, 1002-C, 1002-D from the light strips 402-A, 402-B, 402-C, 402-D. That illumination 802 inhibits biogrowth that is not inhibited by the ultrasonic waves 1002. Additionally, biogrowth on the light array 100-B is avoided or inhibited because the light array 100-B is located within the boundary 1024 that is subject to effective ultrasonic waves 1004.

The protection device 100 includes various functions. The function of creating a zone 154 that is inhospitable to biogrowth is implemented, in one embodiment, by an isolation chamber 100-A such as illustrated in FIGS. 2 & 3. The function of creating a zone 154-B that is inhospitable to biogrowth is implemented, in another embodiment, by a protection device 100-B that projects illumination 1002 toward the submerged device 114 such as illustrated in FIGS. 4-10.

The function of inhibiting biogrowth around submerged equipment 114 is implemented, in one embodiment, by an isolation chamber 100-A such as illustrated in FIGS. 2 & 3. The function of inhibiting biogrowth around submerged equipment 114 is implemented, in one embodiment, by a light array 100-B such as illustrated in FIGS. 4 to 8.

The function of inhibiting biogrowth on a protection device 100 around submerged equipment 114 is implemented, in one embodiment, by the device 100 being located in a zone that is subject to ultrasonic waves 1004 where the ultrasonic waves 1004 inhibit bio-organism viability and/or growth.

From the foregoing description, it will be recognized by those skilled in the art that a protection device 100 has been provided. The protection device 100 inhibits biogrowth in the immediate vicinity of submerged equipment 114. In one embodiment, the protection device 100 includes an isolation chamber 100-A that isolates the water 102 around the submerged equipment 114 from the larger body of water 102 that the equipment 114 is located in. In another embodiment, the protection device 100 includes a light array 100-B that projects light 1002 toward the submerged equipment 114 where that light 1002 is at a wavelength that is inhospitable to biogrowth.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for local algae control around submerged equipment, said apparatus comprising:
a device configured to be submerged in a body of water wherein said device is to be protected from selected bio-organisms;
a support mechanism disposed proximate said device; and
a plurality of light strips attached to said support mechanism, said plurality of light strips defining a zone therebetween, said plurality of light strips having a plurality of lights projecting illumination into said zone.

2. The apparatus of claim 1 wherein said submerged equipment includes an ultrasonic transducer assembly configured to emit ultrasonic waves under water for the control of selected bio-organisms.

3. The apparatus of claim 1 wherein said illumination from said plurality of lights is at a wavelength that is inhospitable to selected bio-organisms.

4. The apparatus of claim 1 wherein said illumination from said plurality of lights includes ultraviolet light at a wavelength that is inhospitable to said selected bio organisms.

5. The apparatus of claim 1 wherein each one of said plurality of lights include a first set of lights and a second set of lights, said first set of lights having said illumination at a first wavelength, and said second set of lights having said illumination at a second wavelength, wherein said first wavelength is inhospitable to a first group of bio-organisms and said second wavelength is inhospitable to a second group of bio-organisms.

6. The apparatus of claim 1 further including a controller operatively connected to said plurality of lights of said plurality of light strips, and said controller powering said plurality of lights with a selected duty cycle.

7. The apparatus of claim 1 wherein said support mechanism includes a support member and a vertical wall with a cylindrical shape; and said plurality of light strips attached to said vertical wall.

8. The apparatus of claim 1 wherein said support mechanism includes a support member, and said plurality of light strips suspended from said support member.

9. The apparatus of claim 1 wherein said support mechanism includes an attachment member and a top ring, said top ring supported by said attachment member, and said plurality of light strips suspended from said top ring.

10. The apparatus of claim 9 wherein said support mechanism further includes a bottom ring, and said plurality of light strips suspended between said top ring and said bottom ring.

11. The apparatus of claim 9 further including a local controller electrically connected to said plurality of light strips, and said local controller attached to said top ring.

12. The apparatus of claim 9 wherein said attachment member includes a local controller electrically connected to said plurality of light strips, and said attachment member includes an enclosure that seals said local controller from a water environment.

13. An apparatus for local algae control around submerged equipment, said apparatus comprising:
an ultrasonic transducer assembly configured to emit ultrasonic waves under water for the control of selected bio organisms; and
an isolation chamber positioned around said ultrasonic transducer assembly, said isolation chamber substantially sealing an environment around said ultrasonic transducer assembly from a body of water surrounding said ultrasonic transducer assembly.

14. The apparatus of claim 13 wherein said isolation chamber has a cylindrical shape, and said isolation chamber being transparent to said ultrasonic waves.

15. The apparatus of claim 13 wherein said isolation chamber has an ellipsoidal shape, and said isolation chamber being transparent to said ultrasonic waves.

16. An apparatus for local algae control around submerged equipment, said apparatus comprising:
an ultrasonic transducer assembly configured to emit ultrasonic waves under water for the control of selected bio organisms;
a support mechanism disposed proximate said ultrasonic transducer assembly; and
a plurality of light strips attached to said support mechanism, said plurality of light strips defining a zone therebetween, said ultrasonic transducer assembly inside said zone, said plurality of light strips having a plurality of lights projecting illumination into said zone, and said illumination from said plurality of light strips is at a wavelength that is inhospitable to selected bio-organisms.

17. The apparatus of claim 16 wherein each one of said plurality of lights include a first set of lights and a second set of lights, said first set of lights having said illumination at a first wavelength, and said second set of lights having said illumination at a second wavelength, wherein said first wavelength is inhospitable to a first group of bio-organisms and said second wavelength is inhospitable to a second group of bio-organisms.

18. The apparatus of claim 16 wherein said illumination from said plurality of lights includes ultraviolet light at a wavelength that is inhospitable to said selected bio organisms.

19. The apparatus of claim 16 wherein said support mechanism includes a support member and a vertical wall with a cylindrical shape; and said plurality of light strips attached to said vertical wall.

20. The apparatus of claim 16 wherein said support mechanism includes a support member, and said plurality of light strips suspended from said support member.

21. The apparatus of claim 16 wherein said support mechanism includes an attachment member and a top ring, said top ring supported by said attachment member, and said plurality of light strips suspended from said top ring.

22. The apparatus of claim 21 wherein said support mechanism further includes a bottom ring, and said plurality of light strips suspended between said top ring and said bottom ring.

23. The apparatus of claim 21 further including a local controller electrically connected to said plurality of light strips, and said local controller attached to said top ring.

24. The apparatus of claim 21 wherein said attachment member includes a local controller electrically connected to said plurality of light strips, said attachment member includes an enclosure that seals said local controller from a water environment, and said local controller encapsulated in an overmold.
